(19) United States
(12) Patent Application Publication
(10) Pub. No.: US 2007/0052961 A1
(43) Pub. Date: Mar. 8, 2007

(54) Method for extending the color gamut for dichroic color mixing systems and colored gobos

(75) Inventors: James D. Lane, Dunedin, FL (US); Philip E. Buchsbaum, Oldsmar, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: Ocean Optics, Inc., Largo, FL (US)

(21) Appl. No.: 11/511,551

(22) Filed: Aug. 25, 2006

Related U.S. Application Data
(60) Provisional application No. 60/714,887, filed on Sep. 7, 2005.

(51) Int. Cl. G01N 21/25

(52) U.S. Cl. 356/406

(57) ABSTRACT

This disclosure describes a multiple channel dichroic color mixing system or gobo that is comprised of three standard filters, one each of cyan, magenta and yellow, in combination with a fourth “multiband” optical filter with a spectral design that has multiple pass and blocking regions such that, by a suitable sequential combination of filters, the resultant transmitted light can be made to have enhanced color and intensity in the blue, green, and red portions of the color spectrum, without sacrificing the colors produced by combinations of the CMY filters that are commonly known in the industry. The “multiband” filter provides an optical solution with a single additional filter that, prior to this disclosure would require the addition of multiple single band filters, thereby increasing the mechanical complexity and overall cost of the color mixing device.

### CROSS-REFERENCE TO PRIOR APPLICATION

The present application claims the benefit of previously filed co-pending Provisional Patent Application, Ser. No. 60/714,887.

### FIELD OF INVENTION

This invention relates to the field of color mixing filter systems and more specifically to a mixing system comprising an extra multiband filter that produces enhanced color and intensity in the blue, green, and red portions of the color spectrum.

### BACKGROUND OF THE INVENTION

Traditional cyan/magenta/yellow (CMY) dichroic color mixing systems and gobos are less than optimal at producing colors in the blue, green, and red range, unless drastic modifications to the CMY filter responses are made. These spectral modifications come at the expense of the filter's intrinsic colors themselves, yielding a color mixing system or gobo with an output that is a poor compromise throughout the entire spectral range.

### SUMMARY OF THE INVENTION

This disclosure describes a multiple channel dichroic color mixing system or gobo that is comprised of three standard filters, one each of cyan, magenta and yellow, in combination with a fourth “multiband” optical filter with a spectral design that has multiple pass and blocking regions such that, by a suitable sequential combination of filters, the resultant transmitted light can be made to have enhanced color and intensity in the blue, green, and red portions of the color spectrum, without sacrificing the colors produced by combinations of the CMY filters that are commonly known in the industry. The “multiband” filter provides an optical solution with a single additional filter that, prior to this invention would require the addition of multiple single band filters, thereby increasing the mechanical complexity and overall cost of the color mixing device.

For a fuller understanding of the nature and objects of the invention, reference should be made to the following detailed description taken in connection with the accompanying drawings.

### BRIEF DESCRIPTION OF THE DRAWINGS

For a fuller understanding of the nature and objects of the invention, reference should be made to the following detailed description, taken in connection with the accompanying drawings, in which:

FIG. 1 is a representation of a cyan filter spectra.

FIG. 2 is a representation of a magenta filter spectra.

FIG. 3 is a representation of a yellow filter spectra.

FIG. 4 is a representation of a multiband filter spectra.

FIG. 5 is a representation of a resultant blue filter spectra.

FIG. 6 is a representation of a resultant photopically green filter spectra.

FIG. 7 is a representation of a resultant red filter spectra.

FIG. 8 is a representation of resultant dimmed filter spectra.

FIG. 9 is a blown up representation of the preferred embodiment of the color mixing device.

### DETAILED DESCRIPTION OF THE INVENTION

The preferred embodiment is comprised of, and not limited to, optical color filters that have circularly varying color density, so that the color saturation of any or all of the filters described can be adjusted to produce a range of mixed colors of the transmitted beam. The described color mixing system can also find applicability to other items well known in the optical engineering and entertainment lighting arts, such as color mixing systems that utilize a set of patterned color filters that are linearly translated in one or more dimensions to effect an overall change in the output color, filter components or assemblies for projection of a multicolor image (dichroic based gobos), as well as other applications where a multitude of filters are used in combination. This color mixing method is applicable to optical filter systems in which the color filter elements are located on one, or multiple, optical surfaces of one or more optical elements used in conjunction to form a color mixing system or multicolor image device. Those skilled in the art will recognize that multiple optical elements encompasses those used as physically separate elements, and alternatively, as mechanically bonded assemblies such as cemented gobos.

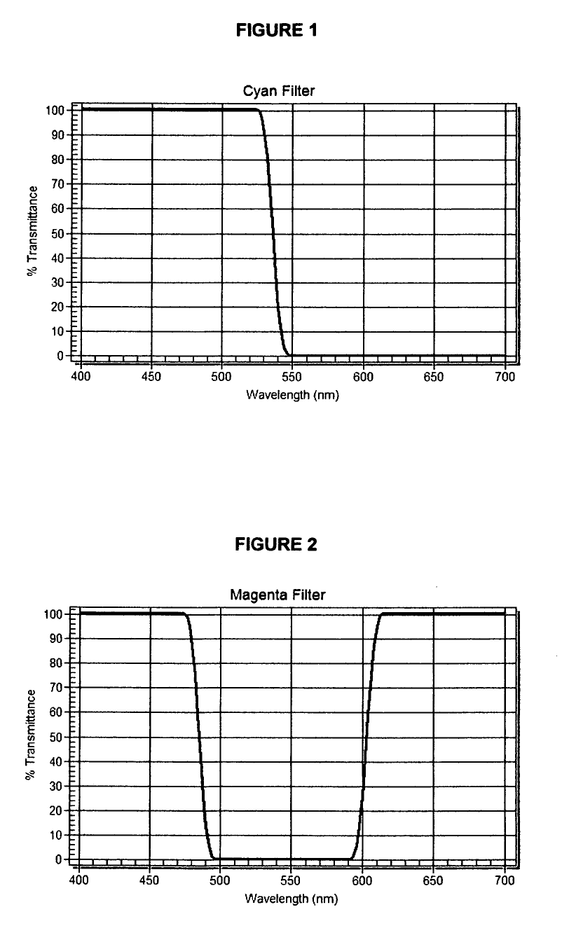

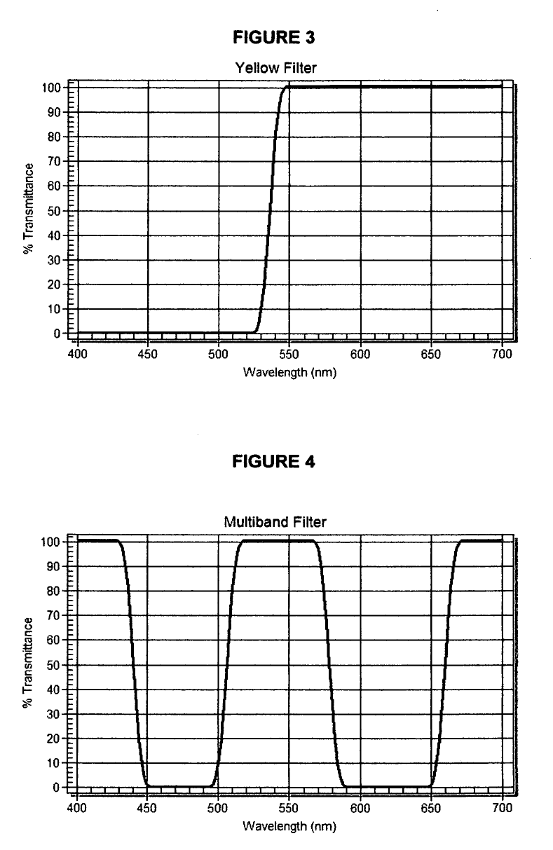

The typical cyan, magenta and yellow filters have spectra similar to FIGS. 1-3. These figures show the spectra of the filters in the full saturation condition for clarity, but those skilled in the art would recognize various amounts of saturation are possible.

The fourth “multiband” filter has a spectral design similar to FIG. 4.

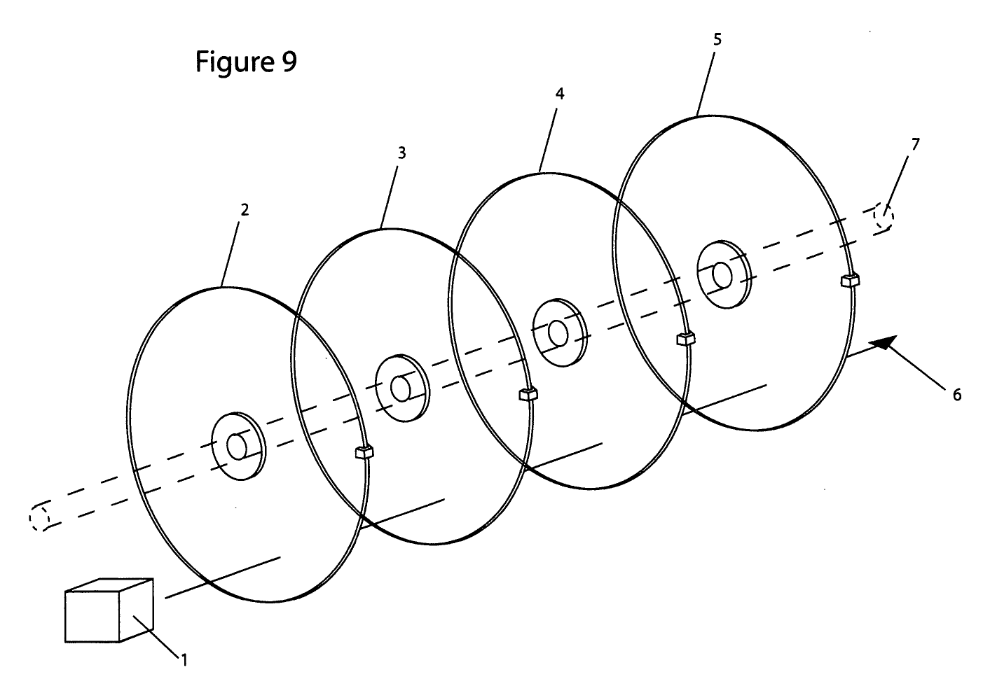

In the blown up representation of the preferred embodiment shown in FIG. 9 the reader can easily recognize that the optical color filters (2 through 5) are rotatably arranged in a linear fashion on a support structure (7) adjacent to the light source (1). Each of the color filters (2 through 5) have circularly varying color density, so that the color saturation of any or all of the filters (12 through 5) described can be adjusted to produce a range of mixed colors of the transmitted beam (6). The physical color order of the filters (2 through 5) does not have a theoretical impact on the performance of the devise but in the preferred embodiment they are, from nearest to the light source (1), multiband filter (2), magenta filter (3), cyan filter (4), and yellow filter (5).

In the preferred embodiment, the multiband filter (2) alone transmits light in three primary spectral regions concurrently, the blue region, the green region, and the red region. Those skilled in the art will recognize that other regions could also be used to create multiband filters such as those having 5 bands for example.

It is important to note that the multiband filter (2) of the preferred embodiment, when used alone, has a visible green photopic color, even though there is a blue and red concurrent transmission.

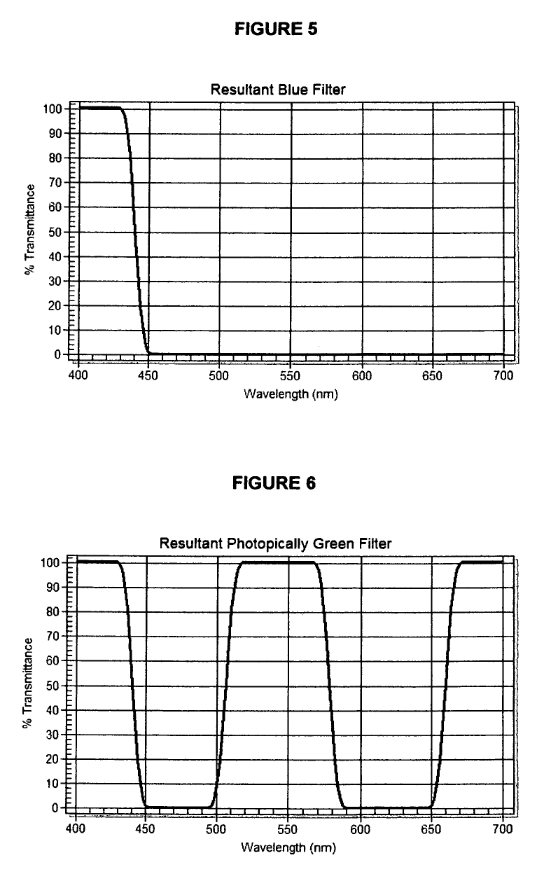

If light in the blue spectral range is desired, the cyan (4), magenta (3), and the multiband filter (2) are combined in the desired saturation amounts to produce blue. The resultant overlapping transmitted spectral color is blue, with the blocking regions of each filter contributing to the overall rejection of light in the non-blue spectral regions producing a spectral result as shown in FIG. 5.

If green output is desired, a combination of cyan (4), yellow (5), and the multiband filter (2) can be selected producing a spectral result as shown in FIG. 6.

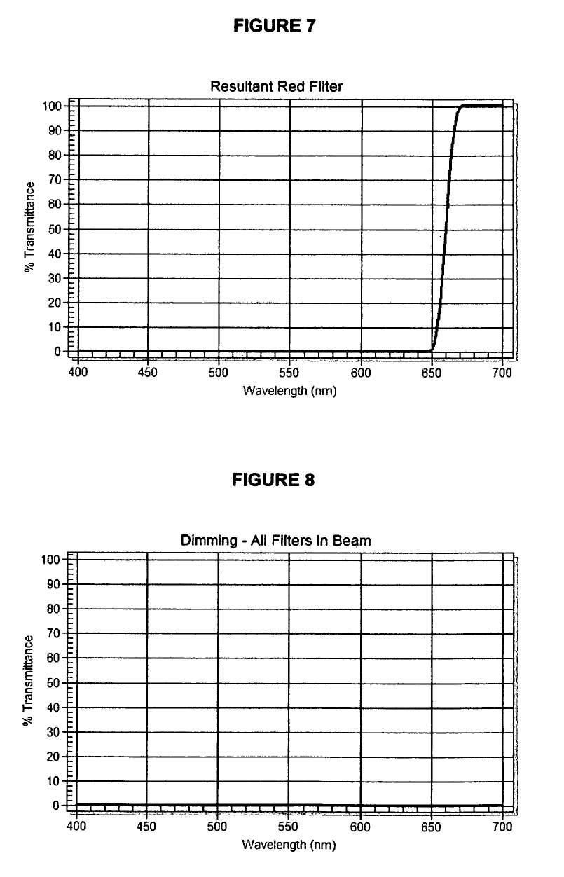

If red output is desired, a combination of yellow (5), magenta (3), and the multiband filter (2) can be selected producing a spectral result as shown in FIG. 7.

Traditional colors can still be produced unchanged if the multiband filter (2) is not utilized in the optical beam (6), i.e. the multiband filter (2) rotated or translated to the “clear” position).

A range of overall intensities and hues can be obtained by various combinations of all four filters, including complex hues that require less overall intensity. The filters can also be used with all filters set to full saturation to provide near-total beam dimming, eliminating the need for a separate dimmer filter or circuit as shown in the spectral result of FIG. 8. Those skilled in the art will recognize that the multiband mixing approach of this disclosure will also find applicability in other areas that use multiple spectral filters such as spectroscopy, or projection display filters.

Since certain changes may be made in the above described color mixing system without departing from the scope of the invention herein involved, it is intended that all matter contained in the description thereof or shown in the accompanying figures shall be interpreted as illustrative and not in a limiting sense.

What is claimed is:

1. A multiple channel color mixing system that is comprised of:
a cyan optical filter;
a magenta optical filter;
a yellow optical filter;
a multiband optical filter;
said multiband optical filter having a spectral design with multiple pass and blocking regions; and,
arranging said filters in a suitable sequential combination of said filters such that the resultant transmitted light can be made to have enhanced color and intensity.

2. The multiple channel color mixing system of claim 1 wherein said multiband optical filter has a clear region such that when it is used with the other said filters the standard filter color of the other said filters can still be produced.

3. The multiple channel color mixing system of claim 1 wherein said filters can also be used with all said filters set to full saturation to provide near-total beam dimming.

4. The multiple channel color mixing system of claim 1 wherein said filters have circularly varying color density such that the color saturation of any or all of said filters can be adjusted to produce a range of mixed colors in the transmitted beam.

5. The multiple channel color mixing system of claim 1 wherein said cyan optical filter, said magenta optical filter, said yellow optical filter, and said multiband optical filter are dichroic filters.

6. The multiple channel color mixing system of claim 1 wherein said multiband optical filter is capable of transmitting light in three primary spectral regions concurrently, the blue region, the green region, and the red region and arranging said filters in a suitable sequential combination of said filters such that the resultant transmitted light can be made to have enhanced color and intensity in the blue, green, and red portions of the color spectrum.
